(19) United States
(12) Patent Application Publication
(10) Pub. No.: US 2021/0146174 A1
(43) Pub. Date: May 20, 2021

(54) Fire Suppression System for Stoves

(71) Applicant: Logan Howlett, Chester, VA (US)

(72) Inventor: Logan Howlett, Chester, VA (US)

(21) Appl. No.: 17/027,073

(22) Filed: Sep. 21, 2020

Related U.S. Application Data
(60) Provisional application No. 62/938,039, filed on Nov. 20, 2019.

(51) Int. Cl. A62C 3/00; A62C 35/64; A62C 37/38

(52) U.S. Cl. CPC A62C 3/006; A62C 35/13; A62C 37/38; A62C 35/64

(57) ABSTRACT

A fire suppression system for stoves is shown and described. The fire suppression system for stoves includes a first pressurized tank filled with a fire suppression material. The first pressurized tank is fluidly connected to a first side of a piping system. A second pressurized tank filled with a fire suppression material. The second pressurized tank is fluidly connected to a second side of a piping system. The piping system has a plurality of nozzles pointing at burners of a stove. A first temperature gauge is connected to a first release device. The first release device will dispense the fire suppression material from the first pressurized tank. A second temperature gauge is connected to a second release device. The second release device will dispense the fire suppression material from the second pressurized tank.

### CROSS REFERENCE TO RELATED APPLICATIONS

This application claims the benefit of U.S. Provisional Application No. 62/938,039 filed on Nov. 20, 2019. The above identified patent application is herein incorporated by reference in its entirety to provide continuity of disclosure.

### BACKGROUND OF THE INVENTION

The present invention relates to fire suppression systems. More particularly, the present invention provides a fire suppression that will quickly reduce fires in a kitchen.

Kitchen fires are a leading cause of house fires. Many of these fires start in the stove area of the kitchen. Kitchen fires may start if an individual becomes distracted or forgets that there are items on the stove. Further, in some instances, items may have a lid on and catch fire when the lid is removed.

A kitchen fire may start small and turn into a major emergency relatively quickly. When a fire begins to grow, it can be difficult to contain it. If the individual is present at the stove, they have to leave the fire unattended to retrieve some way to extinguish it, such as a towel or fire extinguisher. Many times, individuals panic and do not know what to do to put out the flames.

Consequently, there is a need for an improvement in the art of fire suppression systems. The present invention substantially diverges in design elements from the known art while at the same time solves a problem many people face when having a kitchen fire. In this regard the present invention substantially fulfills these needs.

### SUMMARY OF THE INVENTION

The present invention provides a fire suppression system for stoves wherein the same can be utilized for providing convenience for the user when using a fire suppression system for stoves. The fire suppression system for stoves is comprised of a first pressurized tank filled with a fire suppression material. The first pressurized tank is fluidly connected to a first side of a piping system. A second pressurized tank filled with a fire suppression material. The second pressurized tank is fluidly connected to a second side of a piping system. The piping system has a plurality of nozzles pointing at burners of a stove. A first temperature gauge is connected to a first release device. The first release device will dispense the fire suppression material from the first pressurized tank. A second temperature gauge is connected to a second release device. The second release device will dispense the fire suppression material from the second pressurized tank.

Another object of the fire suppression system is to provide securement devices attached to the piping system. The securement devices will connect the system above a stove.

Another object of the fire suppression system is to provide a piping system which is telescopically adjustable in size.

Another object of the fire suppression system is to provide a first temperature gauge and a second temperature gauge that each include a system to determine the actual temperature of the stove at stove level from a position above the stove.

Another object of the fire suppression system is to provide securement devices that are magnets.

Another object of the fire suppression system is to provide a first temperature gauge accepts readings from one half of the burners of the stove and a second temperature gauge accepts temperature readings from a second half of the burners of the stove.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the fire suppression system for stoves.

FIG. 2 shows a top down view of an embodiment of the fire suppression system for stoves.

FIG. 3 shows a close-up view of an embodiment of a nozzle for the fire suppression system for stoves.

FIG. 4 shows a wiring view of an embodiment of a temperature gauge for the fire suppression system for stoves.

FIG. 5 shows a perspective view of an embodiment of the fire suppression system for stoves installed.

FIG. 6 shows a perspective view of an embodiment of an alternative installation of the fire suppression system for stoves.

### LIST OF REFERENCE NUMERALS

With regard to the reference numerals used, the following numbering is used throughout the drawings.

101 Pressurized tank

102 Piping system

103 Connectors

104 Release device

105 Temperature gauge

106 Temperature Reader

107 Plurality of Nozzles

201 Telescopic connections

301 Ball and socket joint

402 Power source

501 Hood

502 Stove

503 Burner

601 Counter surface

### DETAILED DESCRIPTION OF THE INVENTION

Reference is made herein to the attached drawings. Like reference numerals are used throughout the drawings to depict like or similar elements of the fire suppression system for stoves. For the purposes of presenting a brief and clear description of the present invention, a preferred embodiment will be discussed as used for the fire suppression system for stoves. The figures are intended for representative purposes only and should not be considered to be limiting in any respect.

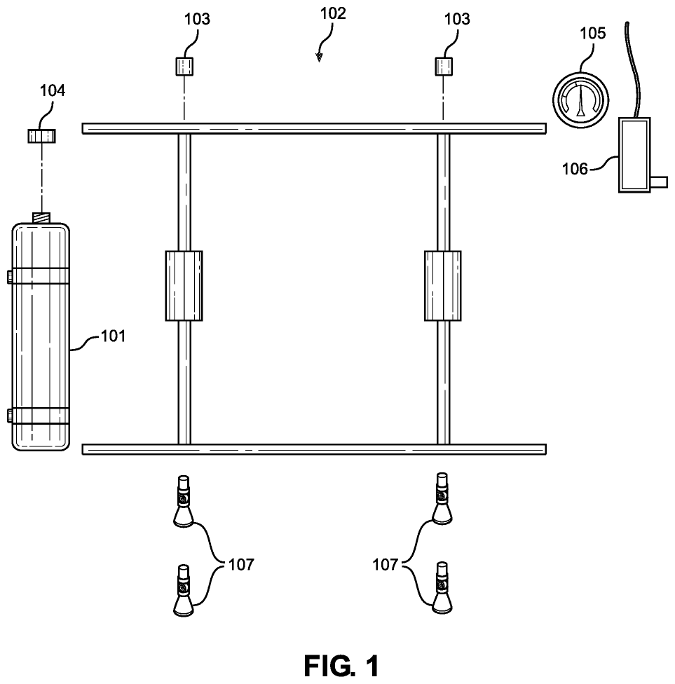

Referring now to FIG. 1, there is shown an exploded view of an embodiment of the fire suppression system for stoves. The fire suppression system includes at least one pressurized tank 101. The at least one pressurized tank 101 is designed to hold fire suppression material. There are many different fire suppression materials currently in use. One of ordinary skill in the art will appreciate that for a system such as this, a fire suppression material that is correct for putting out grease fires should be used. A water-based suppression material should not be used as water may cause several types of common kitchen fires to in fact become worse.

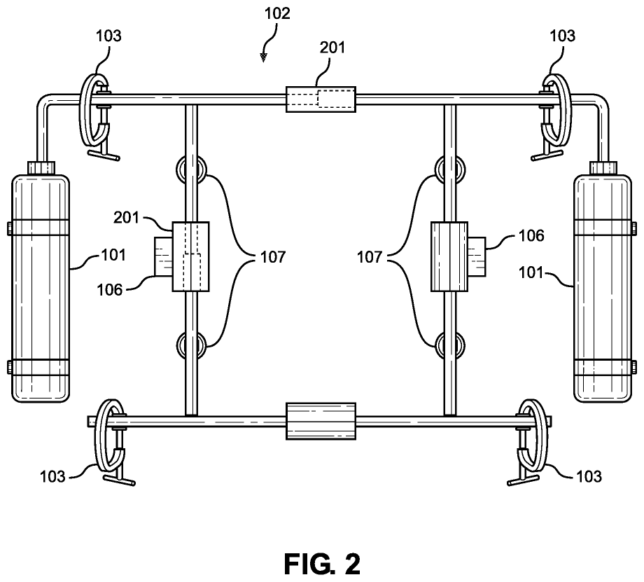

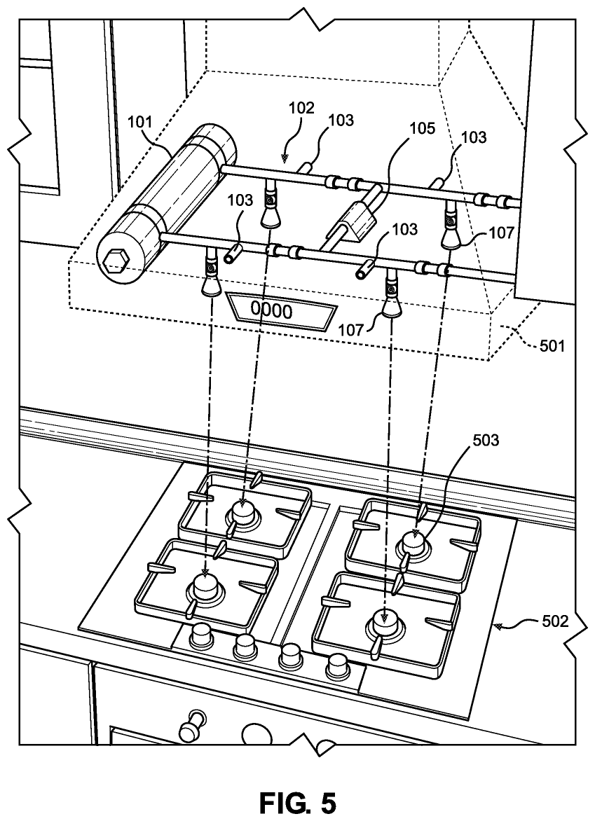

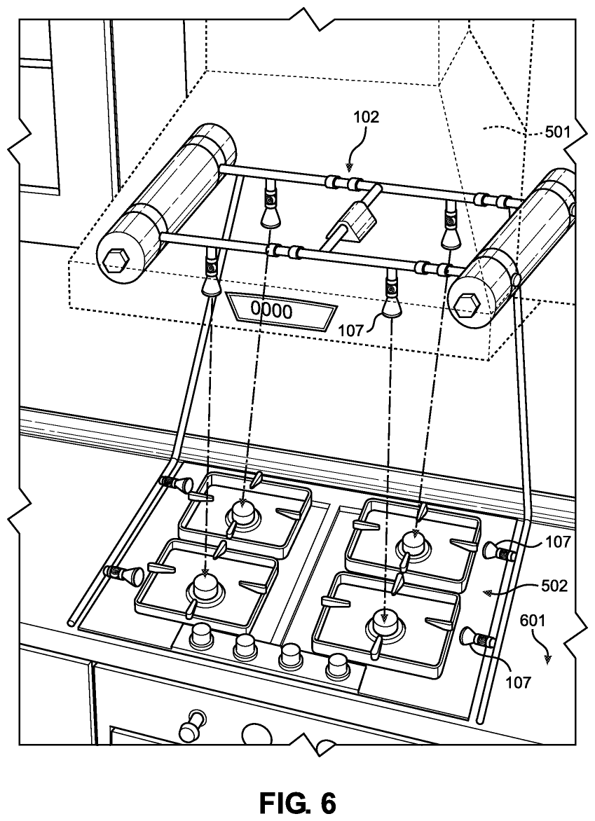

The fire suppression system further includes a piping system 102. The piping system 102 has the dual purpose of securing the system above a stove or other kitchen cooking area as shown in FIG. 5 and FIG. 6, as well as allowing for the fire suppression material to move through the piping system 102 as described herein. In one embodiment, the pipes of the piping system 102 are made from stainless steel. In another embodiment, the pipes of the piping system 102 are made from other materials. The piping system 102 is configured to withstand pressure of the fire suppression material. In one embodiment, the piping system 102 has an adjustable length and width. In one embodiment, the piping system 102 is telescopically adjustable as described in FIG. 2. This will allow the piping system 102 to be easily installed in an existing kitchen. In one embodiment there is parallel piping. The parallel piping will be in line with the front and back of a stove. In further embodiments there are cross pipes. These pipes will ensure that the parallel pipes do not separate. In other embodiments the cross piping fluidly connects the parallel pipes.

The piping system 102 has connectors 103 secured to the ends of several pipes of the piping system 102. The connectors 103 will be used to secure the entire fire suppression system to a kitchen. In the shown embodiment, magnets are used as the connectors 103. Magnets will allow for the device to be secured to the hood above a stove unit.

In one embodiment, the fire suppression system includes a fire suppression material release device 104. The release device 104 will trigger a release of the fire suppression material from the pressurized tank 101. In the shown embodiment, there is only a single release device 104. This release device 104 will allow the fire suppression material to enter the entire piping system 102.

In some embodiments, the fire suppression system includes a temperature gauge 105 and a temperature reader 106. In embodiments including a temperature gauge 105, the temperature gauge 105 will display the temperature recorded by the temperature reader 106. The temperature reader 106 will be pointed toward the stove top. In some embodiments, as described in the description of FIG. 4, the temperature gauge 105 and the temperature reader 106 will trigger the release device 104 upon detection of a threshold temperature.

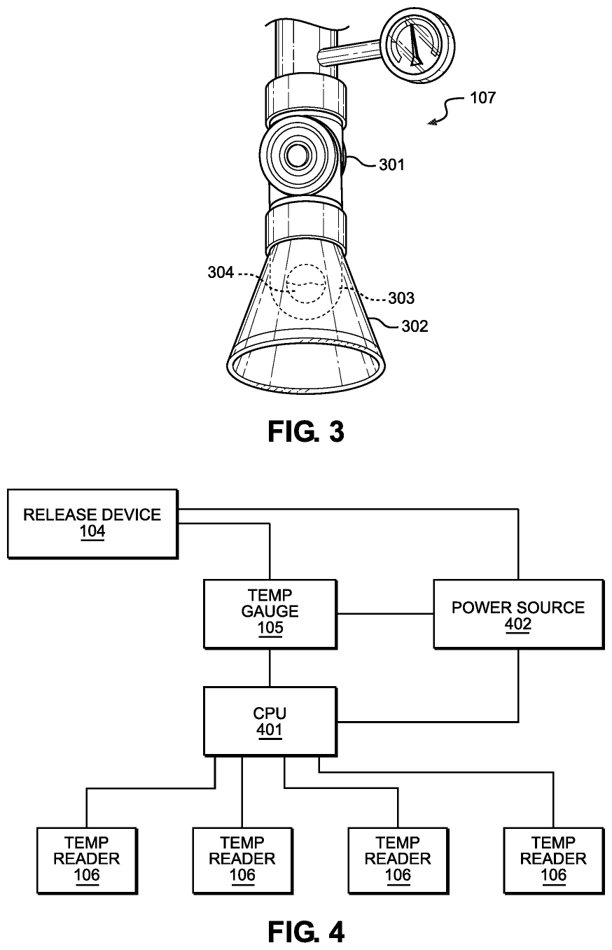

There is a plurality of nozzles 107 secured to the piping system 102. The nozzles 107 will help to direct the fire suppression material towards the stove top. The nozzles 107 will be described further in the description of FIG. 3. In some embodiments, the nozzles 107 will contain a release device 104. Different release devices 104 may be used to have different release types. These devices will be described throughout the description.

Referring now to FIG. 2, there is shown a top down view of an embodiment of the fire suppression system for stoves. In this embodiment, the fire suppression system has two pressurized tanks 101. In one embodiment, there is one pressurized tank 101 for each half of the system. In another embodiment, each pressurized tank 101 will supply fire suppression material to the entire system. In one embodiment, this will allow for the pressurized tanks 101 to be smaller. In another embodiment, this will allow for additional fire suppression material to be stored and used.

In this embodiment, one pressurized tank 101 is fluidly attached to the piping system 102 on each end of the piping system 102. This will allow for the system to be balanced when installed. In some embodiments, there are no release devices located where the pressurized tanks 101 are attached to the piping system 102. Instead, in the shown embodiment, the pressurized tanks 101 are attached directly to the piping system 102. In some embodiments, the release devices are located within each of the plurality of nozzles 107.

In some embodiments, each nozzle 107 has its own release device which is activated via a temperature reader as explained in the description of FIG. 4. In this embodiment, there is shown one temperature reader 106 for each half of the system. This will activate the nozzles 107 on one half of the system if a threshold temperature is reached as described below.

In the shown embodiment, the connectors 103 comprise clamps configured to secure the fire suppression system above a stove. The shown clamps include a threaded device that will turn and tighten a surface in the clamp to secure the fire suppression system in place. Clamps will allow the system to be secured to non-metallic surfaces. Further, in some embodiments, clamps will provide a more secure connection than alternate connectors 103 disclosed herein to better hold the fire suppression system in place.

In many embodiments, the piping system 102 is adjustable. This will allow the piping system 102 to fit within many different sized areas. Further, making the piping system 102 adjustable will allow the system to be easily installed in pre-existing structures. In the shown embodiment, the piping system 102 is telescopically adjustable. In one embodiment there are several telescopic connections 201. In different embodiments the telescopic connections 201 will allow the piping system 102 to extend in both length and width directions. In one other embodiment only the length will extend. In a further embodiment only the width will extend. The telescopic connections 201 are airtight and watertight. This will ensure that the material in the piping system 102 will not escape through the telescopic connections 201.

Referring now to FIG. 3, there is shown a close-up view of an embodiment of a nozzle for the fire suppression system for stoves. In one embodiment, each nozzle 107 has the ability to be targeted in a desired direction to ensure that it targets the stove properly. In one embodiment, each nozzle 107 is comprised of a ball and socket joint 301. The ball will have an aperture therethrough such that fire suppression material may pass through the ball exiting the nozzle 107. In one embodiment, each nozzle 107 will further include a covering 302. The covering 302 will allow for the fire suppression material to expand while still being pointed in the proper location. In the shown embodiment, the covering 302 is a conical covering 302.

In some embodiments, each nozzle 107 will includes a release device. In different embodiments, alternate release devices may be used. In one embodiment, the release device is an electronic release device controlled by the temperature reader. In another embodiment, the release device is a mechanical release device. One of ordinary skill in the art will understand many different release devices exist that will work within this system. For example, a glass ball 303 filled with an expandable substance 304 is used. When the expandable substance 304 heats up it will expand breaking the glass ball 303 and release the fire suppression material.

Referring now to FIG. 4, there is shown a wiring diagram of an embodiment of the fire suppression system for stoves. In one embodiment, the fire suppression system includes at least one temperature reader 106 as described above. The temperature reader 106 will detect temperature at a desired 8. In one embodiment each temperature reader 106 is associated with a specific burner of the stove. This will allow each burner to have its own individual temperature taken potentially catching fires earlier. In one embodiment, each temperature reader 106 is electrically connected to a CPU 401. The CPU 401 will calculate the actual temperature at a specified height above the stove based on the reading of the temperature reader 106 and the height of the temperature reader 106 above the stove. In one embodiment, the CPU 401 will have standard calculations and a user will simply have to record the height when the system is installed. This will help to better determine if there is a fire as the stove burner will be hot and the temperature will rapidly dissipate as the distance above the cooking surface increases.

Once the temperature is calculated, the temperature will be displayed on the temperature gauge 105. The temperature gauge 105 will then activate the release device 104 when a threshold temperature is reached. In one embodiment, the threshold temperature is a higher temperature. This will help to ensure that the system is only triggered in a fire. In another embodiment, the threshold temperature is lower such that the system is triggered in a pre-fire situation. This will hopefully prevent the fire from ever starting.

In the shown embodiment, the CPU 401, the temperature gauge 105, and the release device 104 are all electrically coupled to a power source 402. In one embodiment, the power source 402 is a battery. In this embodiment, the system will be equipped with a low battery indicator. In another embodiment, the power source 402 is a hardwired connection to a home's existing power supply.

Referring now to FIG. 5, there is shown a perspective view of an embodiment of the fire suppression system for stoves installed. In the shown embodiment, there is a single pressurized tank 101 fluidly connected to the piping system 102. The piping system 102 is secured within a hood 501 of a stove 502 via the connectors 103. In the shown embodiment the connectors 103 are magnets. Each of the nozzles 107 of the system are pointed toward a burner 503 of the stove located directly below the nozzle 107. The system further has a single temperature gauge 105 located in the middle of the system. This will allow the temperature gauge 105 to control any combination of release devices.

Referring now to FIG. 6, there is shown a perspective view of an embodiment of an alternative installation of the fire suppression system for stoves. In one embodiment, the device is secured within a hood 501 of a stove 502 as described above. In this embodiment, the piping system 102 further includes pipes that will extend down the rear of the stove 502 toward a counter surface 601. Once the pipes are at the counter surface 601, the pipes will travel inconspicuously along the counter. This will allow for nozzles 107 to be placed level with the burners 503. In one embodiment, this will allow for fire suppression material to be sprayed horizontally into an existing fire.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fire suppression system for stoves, the system comprising:
a pressurized tank filled with a fire suppression material;
the pressurized tank is fluidly connected to a piping system;
the piping system has a plurality of nozzles pointing at one or more burners of a stove;
a temperature gauge connected to a release device, wherein the release device will dispense the fire suppression material.

2) The fire suppression system of claim 1, further comprising securement devices attached to the piping system, wherein the securement devices will connect the system above a stove.

3) The fire suppression system of claim 1, wherein the piping system is telescopically adjustable in size.

4) The fire suppression system of claim 1, wherein the temperature gauge includes a system to determine the actual temperature of the stove at stove level from a position above the stove.

5) The fire suppression system of claim 2, wherein the securement devices are magnets.

6) The fire suppression system of claim 1, wherein the temperature gauge accepts readings from each burner of the stove.

7) A fire suppression system for stoves, the system comprising:
a first pressurized tank filled with a fire suppression material;
the first pressurized tank is fluidly connected to a first side of a piping system;
a second pressurized tank filled with a fire suppression material;
the second pressurized tank is fluidly connected to a second side of a piping system;
the piping system has a plurality of nozzles pointing at burners of a stove;
a first temperature gauge connected to a first release device, wherein the first release device will dispense the fire suppression material from the first pressurized tank;
a second temperature gauge connected to a second release device, wherein the second release device will dispense the fire suppression material from the second pressurized tank.

8) The fire suppression system of claim 7, further comprising securement devices attached to the piping system, wherein the securement devices will connect the system above a stove.

9) The fire suppression system of claim 7, wherein the piping system is telescopically adjustable in size.

10) The fire suppression system of claim 7, wherein the first temperature gauge and the second temperature gauge each include a system to determine the actual temperature of the stove at stove level from a position above the stove.

11) The fire suppression system of claim 8, wherein the securement devices are magnets.

12) The fire suppression system of claim 7, wherein the first temperature gauge accepts readings from one half of the burners of the stove and the second temperature gauge accepts temperature readings from a second half of the burners of the stove.

13) A fire suppression system for stoves, the system comprising:
a pressurized tank filled with a fire suppression material;
the pressurized tank is fluidly connected to a piping system;
the piping system has a first plurality of nozzles pointing at burners of a stove from above;
the piping system further has piping that will travel next to the stove;
a second plurality of nozzles pointing at the burners of the stove from a horizontal plane next to each of the stove burners;
a temperature gauge connected to a release device, wherein the release device will dispense the fire suppression material.

14) The fire suppression system of claim 13, further comprising securement devices attached to the piping system, wherein the securement devices will connect the system above a stove.

15) The fire suppression system of claim 13, wherein the piping system is telescopically adjustable in size.

16) The fire suppression system of claim 13, wherein the temperature gauge includes a system to determine the actual temperature of the stove at stove level from a position above the stove.

17) The fire suppression system of claim 14, wherein the securement devices are magnets.

18) The fire suppression system of claim 13, wherein the temperature gauge accepts readings from each burner of the stove.

19) The fire suppression system of claim 13, further comprising a second pressurized container fluidly connected to the piping system.
